(19) United States
(12) Patent Application Publication
(10) Pub. No.: US 2016/0132880 A1
(43) Pub. Date: May 12, 2016

(54) Authorizing Transactions Using Mobile Device Based Rules

(71) Applicant: Visa International Service Association, San Francisco, CA (US)

(72) Inventors: Alan Joseph O'Regan, Cape Town (ZA); Horatio Nelson Huxham, Cape Town (ZA); Tara Anne Moss, Cape Town (ZA); Hough Arie Van Wyk, Cape Town (ZA)

(21) Appl. No.: 14/899,059

(22) PCT Filed: Jul. 1, 2014
(86) PCT No.: PCT/IB2014/062746

§ 371 Date: Dec. 16, 2015

(30) Foreign Application Priority Data
Jul. 4, 2013 (ZA) 2013/05007

(51) Int. Cl. G06Q 20/40; G06Q 20/32

(52) U.S. Cl. CPC G06Q 20/405; G06Q 20/3226; G06Q 20/3227

(57) ABSTRACT

Rules relating to the authorization of contactless payment transactions may be stored on a mobile device. After provision of contactless payment credentials to a merchant, the mobile device receives a query relating to the authorization of the transaction. The transaction details contained in the query are compared to the rules stored on the mobile device. Depending on the relevant rule applicable, the transaction may either be approved or rejected automatically, or may require user authorization. Depending on input received from the user in response to a prompt therefore, the transaction will be authorized or rejected.

### CROSS-REFERENCES TO RELATED APPLICATIONS

This application claims priority to South African Provisional Patent Application No. 2013/05007 filed on 4 Jul. 2013, which is incorporated by reference herein.

### FIELD OF THE INVENTION

This invention relates to systems and methods for authorizing contactless payments.

### BACKGROUND

Contactless payment systems typically involve a payment unit, such as a credit card, debit card, key fob, smartcard, mobile device or the like which is near-field communication (NFC) enabled to facilitate secure payments. The payment unit is presented to a point of sale (POS) which contains a NFC reader to accept payment credentials transmitted by the payment unit. Payment credentials are then transmitted to the acquiring institution and so forth in the normal manner. The use of contactless payment systems are rapidly increasing, with further increase of acceptance of this technology expected, especially the use of contactless payment systems with the assistance of NFC-enabled mobile devices.

No pin code or signature is typically required for a transaction under a predetermined fixed amount to be approved, while some institutions only allow transactions up to a certain maximum amount to be conducted using contactless payment systems. However, the fixed amount may not be to a user's liking, and the user may wish to alter this limit. Similarly, users may wish to have the convenience of contactless payments with higher payment amounts.

### BRIEF SUMMARY

In accordance with an embodiment of the invention there is provided a method of authorizing transactions using a mobile device, comprising, on the mobile device, the steps of:

setting an automatic authorization rule, where a transaction is to be automatically authorized when the transaction fulfills the automatic authorization rule;

setting a input required rule, where a transaction is to be authorized by a user of the mobile device when the transaction fulfils the input required rule;

storing the automatic authorization and input required rules at the mobile device;

enabling the automatic authorization and input required rules to be configured by a user of the mobile device;

in response to the user providing payment credentials to a merchant and the merchant processing a transaction for payment from the user:
receiving a transaction authorization request;
determining if a rule is applicable to the transaction;
in response to the automatic authorization rule being applicable, automatically authorizing the transaction; and
in response to the input required rule being applicable, prompting the user to authorize the transaction

Further features provide for the method to include the steps of setting and storing an automatic rejection rule, where a transaction is to be automatically rejected when the transaction fulfills the automatic rejection rule; enabling the automatic rejection rule to be configured by a user of the mobile device; and, in response to the user providing payment credentials to a merchant, the merchant processing a transaction for payment from the user, receiving a transaction authorization request, and determining that the automatic rejection rule is applicable, automatically rejecting the transaction.

Still further features provide for the input required rule to require an input from the user in the form of a confirmation indicator or an authentication token to authorize the transaction.

In accordance with one embodiment of the method, the automatic authorization rule may be that a value of the transaction is less than an automatic authorization threshold, and the input required rule is that the value of the transaction is equal to or above the automatic authorization threshold.

In accordance with another embodiment of the method wherein the automatic rejection rule is applicable, the automatic authorization rule may be that a value of the transaction is less than an automatic authorization threshold, the input required rule may be that the value of the transaction is equal to or above the automatic authorization threshold, but less than a rejection threshold, and the automatic rejection rule may be that the value of the transaction is equal to or more than the rejection threshold.

In accordance with a still further embodiment of the method the input required rule may include a first part and a second part, applicability of the first part requiring an input from the user in the form of a confirmation indicator to authorize the transaction, and applicability of the second part requires an input from the user in the form of an authentication token to authorize the transaction. In such an embodiment, the automatic rejection rule may be that a value of the transaction is less than an automatic authorization threshold, the first part of the input required rule may be that the value of the transaction is equal to or above the automatic authorization threshold but below an input required threshold, and the second part of the input required rule may be that the value of the transaction is equal to or above the input required threshold.

In accordance with a yet further embodiment of the invention the automatic rejection rule may be employed in combination with the automatic authorization rule and the input required rule which includes a first part and a second part. In such an embodiment, the automatic authorization rule may be that the value of the transaction is below an automatic authorization threshold, the first part of the input required rule may be that the value of the transaction is equal to or above than the automatic authorization threshold, but below an input required threshold, the second part of the input required rule may be that the value of the transaction is equal to or above the input required threshold, but below a rejection threshold, and the automatic rejection rule may be that the value of the transaction is equal to or above the rejection threshold.

In at least one embodiment of the method, the automatic authorization rule may be that the transaction has any one or more of the properties selected from the group of: originates from a specific merchant; originates from a specific geographic location; occurs during a certain time of day; will not elevate the amount of transactions occurring in a specific time period to a predetermined number; and will not elevate the value of transactions authorized in a specific time period to a predetermined amount.

In a further embodiment of the method, the input required rule and/or the automatic rejection rule may be that the transaction has any one or more of the properties selected from the group of: originates from a specific merchant; originates from a specific geographic location; occurs during a certain time of day; will elevate the amount of transactions occurring in a specific time period to a predetermined number; and will elevate the value of transactions authorized in a specific time period to a predetermined amount. In this embodiment, the input required rule may include a first part and a second part.

In at least some embodiments of the method, the rules are applicable to an account for which payment credentials are stored at the mobile device, or in association with the mobile device.

The invention extends to a system for authorizing transactions using a mobile device, comprising:

a rule component including:
a rule setting component for at least setting an automatic authorization rule, where a transaction is to be automatically authorized when the transaction fulfills the automatic authorization rule and setting a input required rule, where a transaction is to be authorized by a user of the mobile device when the transaction fulfils the input required rule;
a query receiving component for receiving a transaction authorization request in response to a user of the mobile device providing payment credentials to a merchant and the merchant processing a transaction for payment from the user;
a rule applying component for determining if a rule is applicable to the transaction;
an automatic response component for, in response to the automatic authorization rule being applicable, automatically authorizing the transaction;
an input requesting component for, in response to the input required rule being applicable, prompting the user to authorize the transaction;

a secure element in the mobile device for storing the automatic authorization and input required rules at the mobile device

Further features of the system provide for the mobile device to include a memory component for storing an authentication token required to configure the stored rules, and a comparing component for comparing a provided authentication token with the stored authentication token.

In at least some embodiments of the system, the mobile device may be equipped with a hardware security module (HSM); the HSM may be a cryptographic expansion device; the rules may be stored on a non-volatile memory element of the HSM, or in a non-volatile memory element associated with the HSM; configuration of the rules may require authentication in the form of an authentication token; and the configuration token may be selectable from the group consisting of a Pin code, a pass code, a password and a passphrase.

The invention also extends to a computer program product for authorizing transactions using a mobile device, the computer program product comprising a computer-readable medium having stored computer-readable program code for performing the steps of:

setting an automatic authorization rule, where a transaction is to be automatically authorized when the transaction fulfills the automatic authorization rule;

setting an input required rule, where a transaction is to be authorized by a user of the mobile device when the transaction fulfils the input required rule;

storing the automatic authorization and input required rules at the mobile device;

enabling the automatic authorization and input required rules to be configured by a user of the mobile device;

in response to the user providing payment credentials to a merchant and the merchant processing a transaction for payment from the user:
receiving a transaction authorization request;
determining if a rule is applicable to the transaction;
in response to the automatic authorization rule being applicable, automatically authorizing the transaction; and
in response to the input required rule being applicable, prompting the user to authorize the transaction.

Further aspects of the invention provide for a method of authorizing transactions using a mobile device, comprising, on the mobile device:

setting a first rule, where a transaction is to be automatically authorized when the transaction fulfills the first rule;

setting a second rule, where a transaction is to be authorized by a user of the mobile device being prompted to confirm the transaction when the transaction fulfills the second rule;

setting a third rule, where a transaction is to be authorized by a user of the mobile device being prompted to enter an authentication token to confirm the transaction when the third rule is applicable;

storing the first, second and third rules;

enabling the first, second and third rules to be configured by a user of the mobile device;

in response to the user providing payment credentials to a merchant and the merchant processing a transaction for payment from the user:
querying the mobile device to determine that the first rule, second rule or third rule is applicable to the transaction;
in response to the first rule being applicable, automatically authorizing the transaction;
in response to the second rule being applicable, prompting the user to confirm the transaction and authorizing the transaction only if the user responds to the prompt; and

in response to the third rule being applicable, prompting the user to enter an authentication token and authorizing the transaction only if the authentication token corresponds to a previously stored authentication token.

### BRIEF DESCRIPTION OF THE DRAWINGS

FIG. 1 illustrates a flow diagram of a method of authorizing transactions using a mobile device in accordance with an embodiment of the invention;

FIG. 2 illustrates a system for performing the method of FIG. 1;

FIG. 3 illustrates a mobile device when a first part of an input required rule is invoked according to aspects of the method;

FIG. 4 illustrates a mobile device when a second part of an input required rule is invoked according to aspects of the method;

FIG. 5 illustrates a flow diagram of a method of authorizing transactions using a mobile device in accordance with a further embodiment of the invention;

FIG. 6 illustrates a flow diagram of a process for deciding which rule is applicable according to aspects of the method;

FIG. 7 shows a block diagram of a mobile device of a system in accordance with an embodiment of the invention;

FIG. 8 shows a block diagram of a mobile device that may be used in embodiments of the disclosure; and

FIG. 9 illustrates an example of a computing device in which various aspects of the disclosure may be implemented.

### DETAILED DESCRIPTION

Rules relating to the authorization of contactless payment transactions may be stored on a mobile device. Contactless payment transactions typically involve the transmission of payment credentials from a near-field communications (NFC) enabled device to a merchant's NFC reader, whereafter the merchant transmits the credentials to an issuing bank for clearance of the transaction. After provision of contactless payment credentials to a merchant, the mobile device may receive a query relating to the authorization of the transaction. The transaction details contained in the query may be compared to the rules on the phone, and the transaction either approved or rejected after input received from the user, or without the need for input from the user.

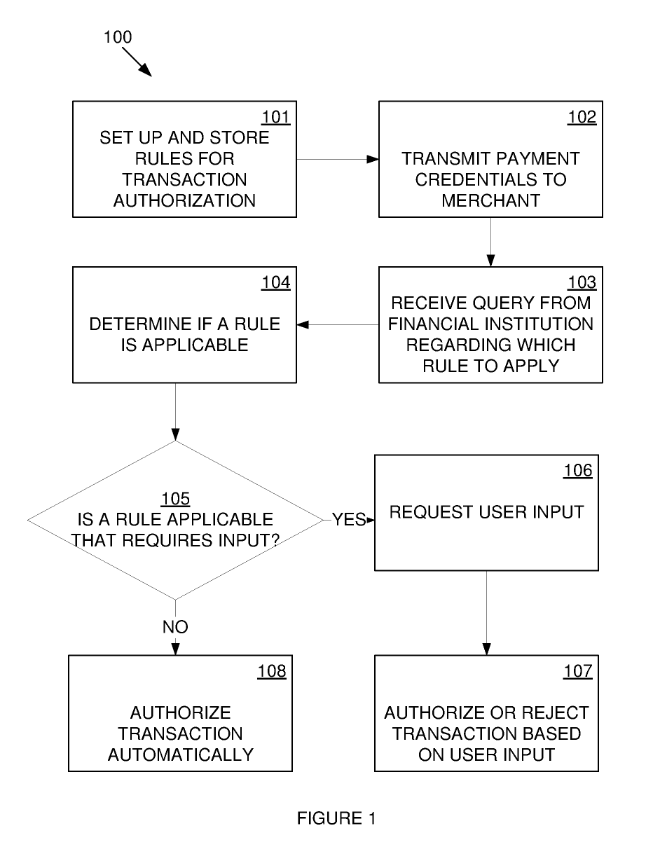

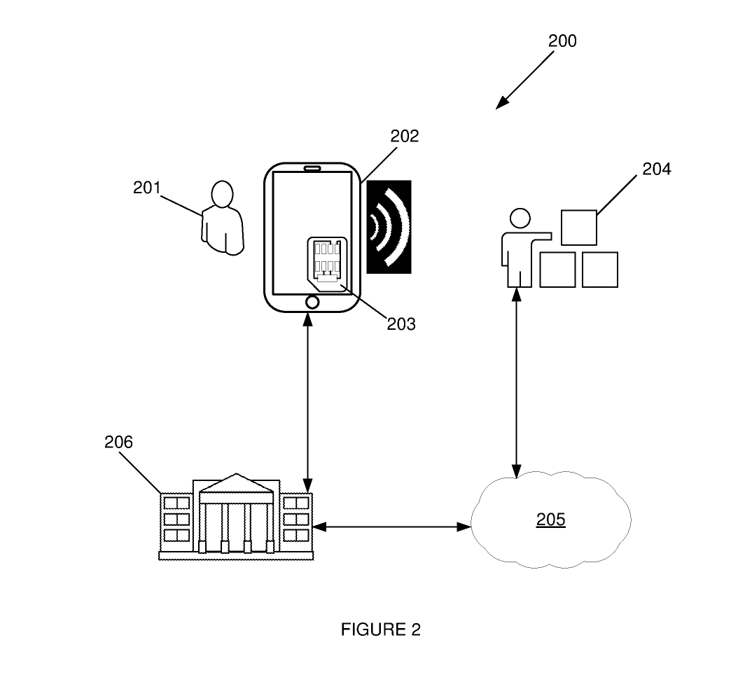

FIG. 1 illustrates a flow diagram (100) of an embodiment of a method for authorizing transactions in accordance with the invention. FIG. 2 illustrates a system (200) for performing this method. In a first step (101) the user (201) sets up rules required for operation of the method. The rules are stored on a secure element (203) associated with the user's mobile device, in the present embodiment a mobile phone (202).

The secure element (203) may be, for example, in the form of a hardware security module (HSM). The secure element (203) may be embedded in the mobile device, or disposed within a universal integrated circuit card (UICC) such as a SIM card, micro SIM card or the like.

In a further embodiment, the secure element (203) may be provided as a cryptographic expansion device which may be connected to or disposed within the mobile device. A cryptographic expansion device may be a label, tray or card which is placed in between a UICC and a UICC interface of the mobile device such that the secure element can intercept and appropriately process any communication sent between the UICC and the mobile device and consequently, between the mobile device and a mobile communication network

In one embodiment, the secure element (203) may be a hardware security module (HSM) which uses hardware to encrypt and decrypt data instead of solely performing the encryption/decryption in software, and accordingly provides enhanced protection over software encryption technologies. In some embodiments, the HSM may be implemented as a dual processor device that includes a secure processor with storage and a public processor with storage.

The secure element (203) restricts unauthorized access to, or configuration of, the rules. The secure element (203) will require authentication of the user prior to allowing access to the rules. The user may, for example, be required to enter an authentication token such as a pass code, such as a PIN code, passcode or pass phrase, before they are allowed to access, modify and/or store any rules. This may prevent unauthorized access to the rules so that an unscrupulous party may be prevented from freely accessing the rules. It is envisaged that a number of subsequent incorrect authentication token entries may temporarily suspend access to the rules. The rules may be stored in the secure element (203) in an encrypted format to increase the security thereof.

Payment credentials for payment via NFC may also be stored in the secure element (203) or may be stored externally, for example, in a cloud-based server for use with host card emulation (HCE) which enables network-accessible storage external to the mobile device with an application on the mobile device configured to emulate card functions.

In the present embodiment, at least an automatic authorization rule and an input required rule are set up by the user in the first step (101). The rules are stored in the secure element.

The automatic authorization rule sets conditions whereunder transactions will be automatically authorized. In the present embodiment, the condition is that the value of a transaction to be authorized is below an automatic authorization threshold.

The input required rule sets conditions whereunder user input is required to authorize the transaction. In the present embodiment, the condition is that the value of a transaction is equal to or above the automatic authorization threshold.

The input required rule may include two parts, each part requiring a different type of input from the user (201) in order to authorize a transaction. The first part of the input required rule requires a confirmation indicator from the user to authorize the transaction, for example selecting “YES” or other form of confirmation on a prompt appearing on a user's mobile device. The first part of the input required rule has the condition that the value of the transaction is above the automatic authorization threshold, but below an input required threshold. The second part of the input required rule requires an authentication token, for example a PIN code, from the user to authenticate the user and thereby to authorize the transaction. The authentication token, or an offset thereof, may be stored on the mobile device, and preferably on the secure element. The authentication token received from the user will be compared to the token stored on the mobile device. If the received token corresponds to the stored token, the transaction is authorized. If the tokens do not match, the transaction may be rejected, or the user may be given another try to enter a correct token. It is envisaged that a number of subsequent incorrect token entries may temporarily suspend a user's account. The second part of the input required rule has the condition that the value of the transaction is equal to or over the input required value.

In an example embodiment, the automatic authorization threshold for the automatic authorization rule may be for transaction values below $10. An input required threshold for the first part of the input required rule may be for example for transactions between $10 and $20. The second part of the input required rule may apply for transactions above $10. Additional rules and thresholds may also be set and stored at the mobile device (202).

In a second step (102), the user (201) transmits his or her payment credentials to a merchant (204) in a normal manner. With contactless payment transactions with the assistance of an NFC-enabled mobile device, this will occur when the user presents their NFC-enabled mobile phone (202) to a NFC-reader enabled point of sale of a merchant (204), or brings the mobile phone close enough to the NFC-reader for the mobile phone to transmit the payment credentials to the merchant's NFC reader.

The merchant (204) processes the transaction by transmitting the payment details in any acceptable way and over any acceptable communication network (205) so that it reaches a financial institution of the user, which is responsible for authorizing the transaction from a financial account of the user. The user's financial institution is typically referred to as an “issuer” (206). In the remainder of the specification, the term “issuer” should be construed to mean the entity who has to approve the transaction, typically the issuing bank of the user.

The issuer (206) in turn transmits a query to the mobile phone (202) of the user (201) associated with the payment credentials, the query including information related to the transaction. The mobile device (202) receives this query in a third step (103). The mobile device consults the secure element (203) on which the rules are stored in order to determine if a rule applies to the current transaction in a fourth step (104).

In a fifth step (105) the mobile device (202) determines whether input is required from the user (201) based on the rule that is applicable. If it is determined that the automatic authorization rule is applicable, where no input is required from the user and the transaction is to be automatically authorized, the mobile device automatically transmits a transaction authorization request back to the user's financial institution (206), as required, in a final step (108). The fact that the transaction has been authorized is also transmitted to the merchant from the financial institution (206) in the form of a confirmation of the successful transaction.

If, however, the input required rule is determined to be applicable in the fifth step, input from the user (201) is required in a further step (106). The mobile device displays a prompt requiring user input. If the first part of the input required rule is applicable, the user is requested to authorize the transaction through a confirmation indicator. If the second part of the input required rule is applicable, the user is prompted to enter the relevant passcode on the mobile device to authenticate themselves and thereby to authorize the transaction. Depending on the result of the input of the user, a transaction authorization message or a transaction denial message is transmitted to the financial institution (206) in a final step (107). A transaction denial message may automatically be sent if the user has not responded to a prompt in a predetermined time period. This may be referred to as “timeout” of the transaction.

Once again, if the transaction has been successfully authorized, this fact is communicated to the merchant (204), who receives a successful transaction message. If the transaction has been rejected due to the entering of an incorrect passcode or a failure on the user's side to authorize the transaction, this may also be communicated to the merchant (204).

It is envisaged that the secure element (203) which may be used with embodiments of the invention may include embedded processors and storage capabilities that can be used to implement a Federal Information Processing Standards (FIPS) compliant hardware security module (HSM) to provide the communication device with the set of security features and functions as found in industry-standard HSMs. When used with a communication device, the secure element enables the communication device to send and receive end-to-end secure communications, and enables mobile operators to utilize their otherwise unsecure communication channels to send and receive encrypted communications. Furthermore, if the secure element (203) is in the form of a cryptographic expansion device, it can be used with a communication device without requiring any changes to the internal software or hardware of the communication device and without requiring any modification to the communication protocols of the communication device. Thus, the cryptographic expansion device can be widely deployed in a cost-effective and efficient way. In some embodiments, the end-to-end secure communications enabled by the cryptographic expansion device can be utilized by a user of the communication device to perform financial and/or banking transactions. The present system extends the functionality of the cryptographic expansion device to include a memory element for storing privileged information, in this situation the rules set up by the user.

Although a mobile phone is used in the description of the method of FIG. 1 and the system of FIG. 2, any mobile device may be used, including, but not limited to, a tablet, a personal digital assistant, or the like.

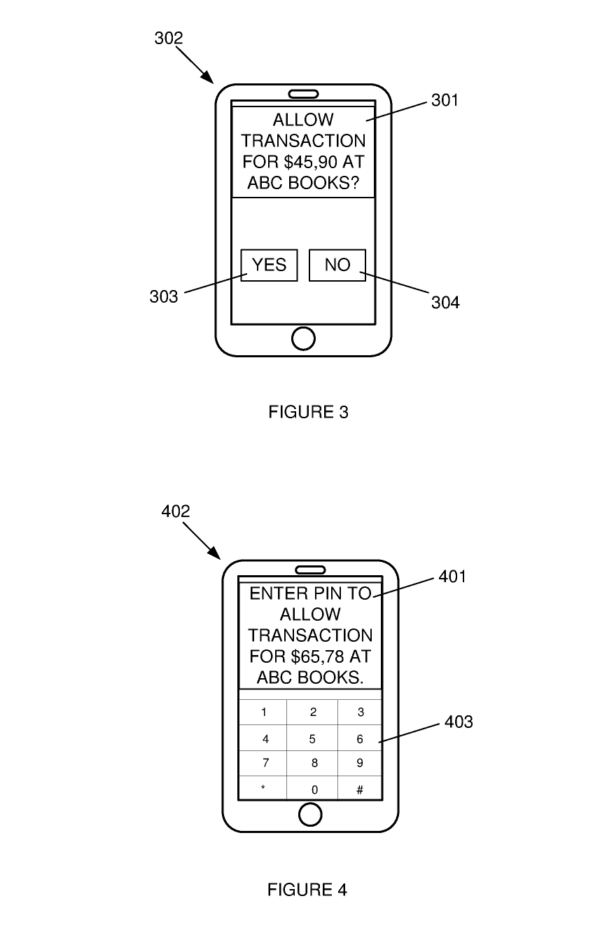

FIG. 3 and FIG. 4 each show an example of prompts a user may receive on their mobile device during operation of the method described with reference to FIG. 1. If the first part of the input required rule is applicable, the user is presented with a prompt (301) on their mobile phone (302), as is shown in FIG. 3. If the user selects “YES” (303), the transaction is authorized, and the relevant authorization message is transmitted to the issuing bank. If the user selects “NO” (304), the transaction is not authorized and a transaction rejection message is sent.

If the second part of the input required rule is applicable, a user is presented with a prompt (401) requesting the entry of their pin code on a key pad (403) of their mobile phone (402) to authorize the transaction, as shown in FIG. 4. If the user enters the correct PIN code, a transaction authentication message is sent to the user's financial institution. If a PIN is incorrectly entered or the message is dismissed, a transaction rejection message is sent to the issuing bank.

It would be appreciated that no prompt would need to be received by or displayed on the user's mobile phone if the automatic authorization rule is applicable.

It is envisaged that an automatic rejection rule may also be implanted. This rule may be that the value of a transaction is above an automatic rejection threshold, for example $50. If any transaction authorization request is then received from an issuing bank relating to a transaction with a value above the automatic rejection threshold, the transaction will automatically be rejected without requiring user input. As with the automatic authorization rule, no prompt will need to be displayed to the user if the automatic rejection rule is applicable.

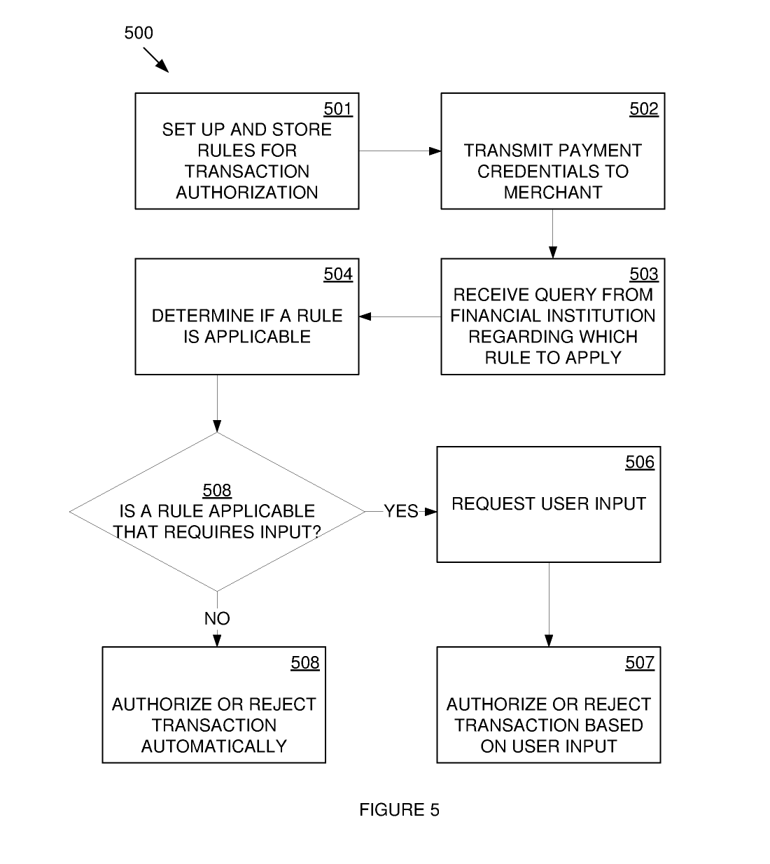

FIG. 5 shows a flow diagram (500) representing a method which includes an automatic rejection rule in addition to the previously described rules. The method includes the same automatic authorization rule and input required rules as the method described with reference to FIG. 1. Accordingly, the method operates in substantially the same way as the method described with reference to FIG. 1. In a first step (501), the user sets up and stores the rules relating to transaction authorization. In a second step (502), the user presents their payment credentials to a merchant, typically through means of NFC communication. In a third step (503), the mobile device of the user receives a query relating to whether a rule must be applied. In the fourth step (504), the mobile device determines whether one of the stored rules is applicable. If a rule is applicable, the mobile phone determines whether the applicable rule requires user input in a fifth step (505). If user input is required, the mobile device prompts the user for authorization for the transaction. The transaction is then approved or denied depending on the input received from the user.

If, however, it is determined in the fifth step (505) that the rule does not require user input, there is an additional possibility in the operation of the method which differs from the method of FIG. 1. If the automatic rejection rule is applicable, the transaction will be automatically rejected. A rejection message will be transmitted to the issuing bank without requiring user input, and would typically also be communicated to the merchant.

In the examples explained above, only the values of transactions have been used to define the various rules so as to determine when each rule will be applicable. It is envisaged that many other properties may be used in defining the rules, or may be used in combination with the value of a transaction, in order to determine which rule is invoked by a specific transaction.

Properties which may be incorporated into the rules may be the geographical origin of a transaction, the specific merchant from which the transaction originates, a type of merchant from which the transaction originates, the time of day at which the transaction originates, or the like.

It is envisaged that a transaction which will result in the user having spent more than a predetermined amount in a predetermined time period, for example spending more than $2,500 in a month, may invoke the input required rule. Similarly, a transaction which will result in a predetermined amount of authorized transactions to be exceeded in a predetermined time period, for example more than 5 transactions in a day, may also invoke the input required rule. Counters may be provided at the mobile device which keeps track of the amount spent in a time period, or the amount of transactions that have been authorized in a time period, to enforce this rule.

It would be appreciated that these rules may be tailored to suit a user's needs or requirements. A user interface may be provided on the mobile device which may assist the user in configuring the rules. Rules may also operate on an either/or condition. For example, any transaction under an automatic authorization threshold is automatically allowed, unless the transaction originates outside a predetermined geographical area, in which the input required rule is applicable. This will allow a user to precisely set rules adapted for their needs and based on their payment habits.

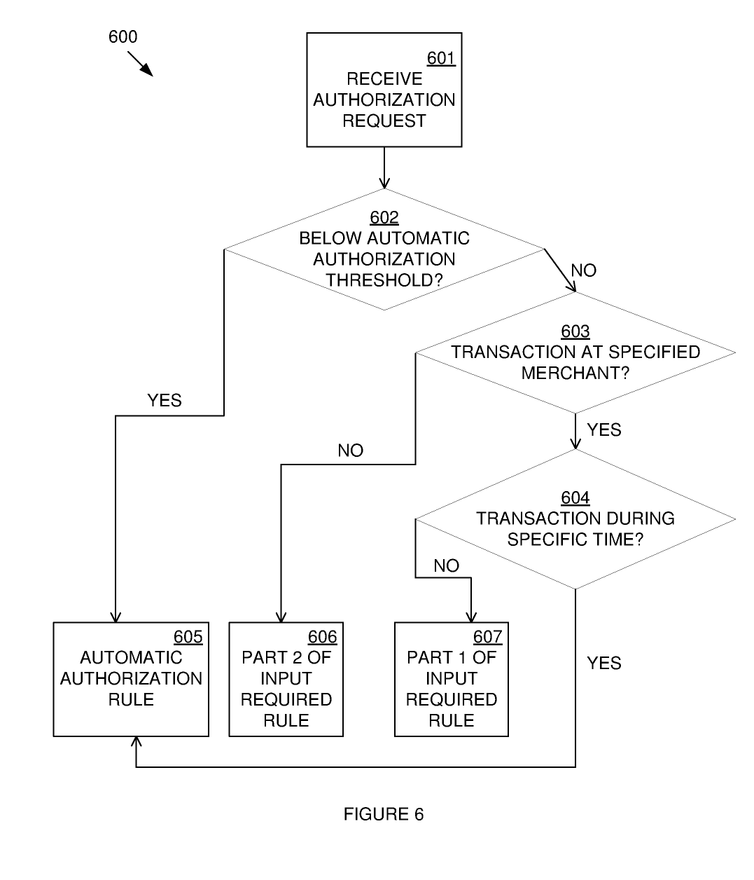

FIG. 6 shows a flow diagram (600) of a more complex rule system. This rule system includes an automatic authorization rule and an input required rule with a first part and a second part. The properties of the transaction will be received and analyzed by the mobile device at the time of receiving (601) the authorization request so as to follow the applicable rule or rules.

In the present embodiment shown in the flow diagram (600), the mobile device determines if the value of the transaction is below an automatic authorization threshold value (602) in response to receiving an authorization request (601). Any transaction which has a value below an automatic authorization threshold value invokes the automatic authorization rule (605) and is automatically approved, regardless of where the transaction originates from. If the value is over the automatic authorization threshold, the mobile device checks whether the transaction occurs at any of a list of specified merchants in a next step (603). If the transaction did not occur at any of the specified merchants, the second part of the input required rule is invoked (606), and the user is required to enter an authentication token. If the transaction did occur at a specified merchant, the mobile device checks if the transaction occurred in a specified time period in a next step (604). If the transaction occurred outside this time period, the first part of the input required rule is invoked (607), and the user has to provide a confirmation indicator to authorize the transaction. If the transaction occurred outside the specified time period, the automatic authorization rule is invoked (605) and the transaction is automatically authorized.

In an example embodiment, the automatic authorization threshold for the automatic authorization rule may be for transaction values below $10. The specified merchant list may include a list of merchants that a user is likely to visit, such as favorite grocery stores and/or clothing stores. The list may also include an entire shopping center. The specified time period may be a time period immediately after a user normally finishes work, for example from 17:30 until 19:00.

The process described with reference to FIG. 6 to determine which rule is applicable may incorporate any number of properties set up by the user in order to determine which rule should be applied to authorize, or to reject, a transaction. A user may wish to limit the use of his or her mobile device for contactless payments outside a specific area for the event that the user's mobile device is stolen. The automatic rejection rule may then be invoked for any transaction that occurs outside a specific geographic area, for example outside a town, a city, a state, a province, a country or the like. A user may wish that transactions at certain types of merchants, for example merchants which users often frequent when in a hurry, always invoke the first part of the input required rule so that the user is only prompted to select “YES” on their mobile device to authorize the transaction. Examples of such merchants include convenience stores, golf pro shops, or the like. A user may also wish to set up a rule so that transactions at specific merchants, for example a transaction at a gas station, always invokes the second part of the input required rule so that a password, typically a PIN code, is required to authorize the transaction.

Further examples of rules that a user may wish to set up, include that all transaction that occur between certain times always invoke the second part of the input required rule, for example any transaction which occur between midnight and 08:00. Any transaction which would cause the user's overdraft facility to activate or cause available funds in the overdraft facility to be used may invoke the automatic rejection rule. Transactions which would increase the total amount that the user has spent in a day, a week, a month or the like over a certain threshold may invoke the first part of the input required rule. It is envisaged that rules may be customized and terms associated with the rules combined so that the authorization can be largely modified as to the user's liking.

It is also envisaged that, should user input be required due to the input required rule being applicable, the user may be informed of the reason for the rule's applicability while being prompted for input. For example, a prompt for authentication requiring a PIN code may indicate to the user that authorization of the current transaction will activate the overdraft facility of their financial account, or the like.

The system may also be configured so that a transaction is automatically rejected if a user has not responded to a prompt, or a user's response has not been received by the issuing bank, within a certain time period, for example within 30 seconds. Should a user enter an incorrect PIN code, the financial institution may transmit this fact to the user's mobile device and prompt them for another PIN code. The user may be offered the option of re-entering their PIN-code only a finite number of times, for example 3 times. After a third unsuccessful attempt, the transaction may be denied. A user's account may also be temporarily suspended in such a situation, as incorrect PIN entry may point to attempted fraudulent activity on the user's account. If a user rejects a certain transaction by selecting “NO”, and a denial message is transmitted to the financial institution, the same transaction may be initialized by the presentation of the user's payment credentials immediately afterwards. This would typically occur when the user has inadvertently selected “NO”. Should a user again select “NO”, this may also point to attempted fraudulent activity, with the accompanying temporary suspension of a user's account.

It should be noted that, with the present system, the issuing bank only expects a transaction authorization or a transaction denial message. The financial institution is not concerned with the properties of the rules, but merely with the message it receives. As such, the rules are set up, configured, changed and used without input from the financial institution. The rules function only as per the user's liking, providing a form of security with a level chosen and controlled by the user himself or herself.

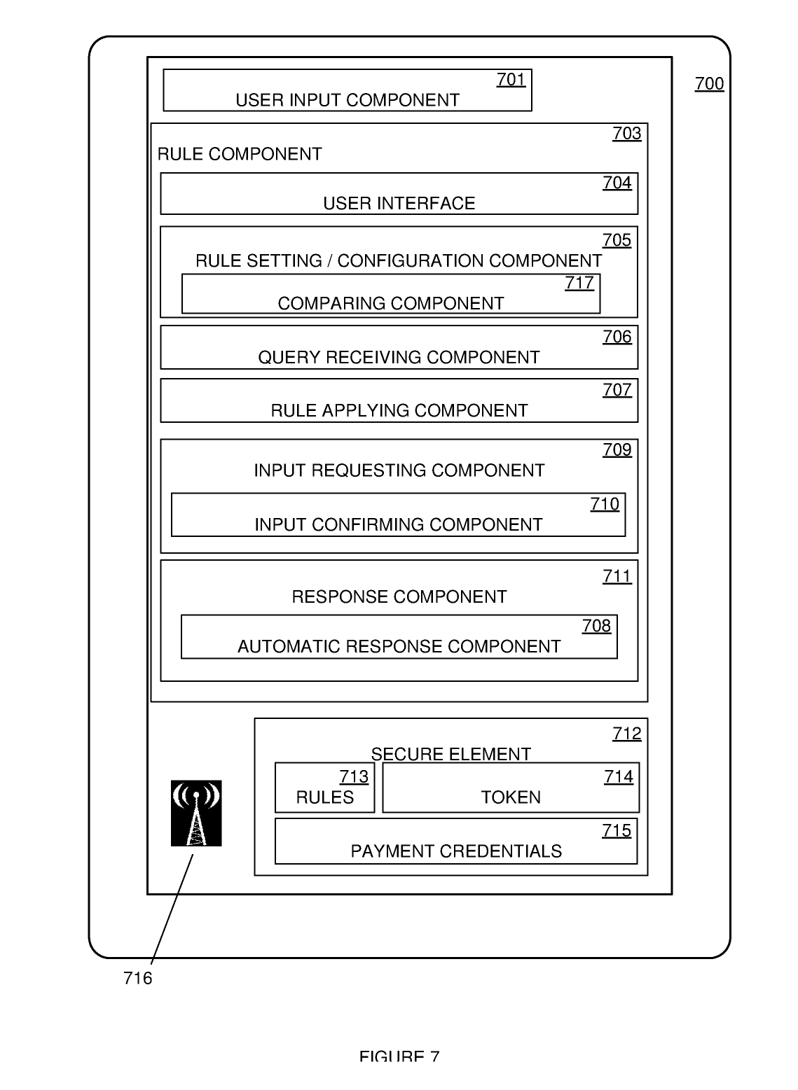

FIG. 7 shows a mobile device (700) for use in a system for authorizing transactions in accordance with described embodiments. In one embodiment, the mobile device (700) is a mobile phone. The mobile phone includes a user input component (701) for receiving user input which may be any standard input component associated with a mobile device, including a keypad, a touch screen, or the like. The mobile phone includes a communication component (716) for receiving and transmitting messages via data channels, mobile cellular channels or other means.

The mobile phone also includes a rule component (703) which manages operation of the locally stored rules. The rule component (703) may use a processor which may form part of the mobile phone itself, or may be incorporated into a secure element such as an HSM associated with the mobile device.

The rule component (703) includes a user interface (704) which assists and/or guides a user in setting up rules, a rule setting and configuration component (705) which manages the setting of the various rules relating to the authorization of transactions. The rule setting and configuration component (705) may include a comparing component (717) to verify a user to allow a user to configure the rules. The comparing component (717) may verify an input by a user against a token stored at a token storing component (714) of the secure element (712).

The rule component (703) also includes a query receiving component (706) for receiving a transaction authorization request in response to a user of the mobile device providing payment credentials to a merchant and a merchant processing a transaction for payment from the user. The rule component (703) also includes a rule applying component (707) for applying the stored rules to a received transaction authorization request.

The rule component (703) may further include an input requesting component (709) for, in response to an input required rule being applicable, prompting the user to authorize the transaction. The input requesting component (709) may include an input confirming component (710) for confirming if the input of the user is sufficient.

The rule component (703) also includes a response component (711) for sending a response further to the transaction authorization request. The response component (711) includes an automatic response component (708) for, in response to an automatic authorization rule being applicable, automatically authorizing the transaction. The response component (711) may provide a positive response to a successful authorization for the transaction via input of the user. The response component (711) may also provide a transaction denial response if the rules are not met or a response is not received from a user in a specified time. A transaction denial response may be sent if a rule generates an automatic rejection. The response component (708) may transmit the response to the rules using the communication component (716).

The mobile phone also includes a secure element (712) which includes secure storage components. The secure storage components include a rule storing component (713), a token storing component (714), and a payment credential storing component (715). The rule storing component (713) stores the rules relating to authorization of transactions, the token storing component (714) stores a token which has to be provided in order to store, access and/or modify the rules stored in the rule storing component, while the payment credential storing component (715) stores the payment credentials that are to be provided to a merchant in order to initialize the method.

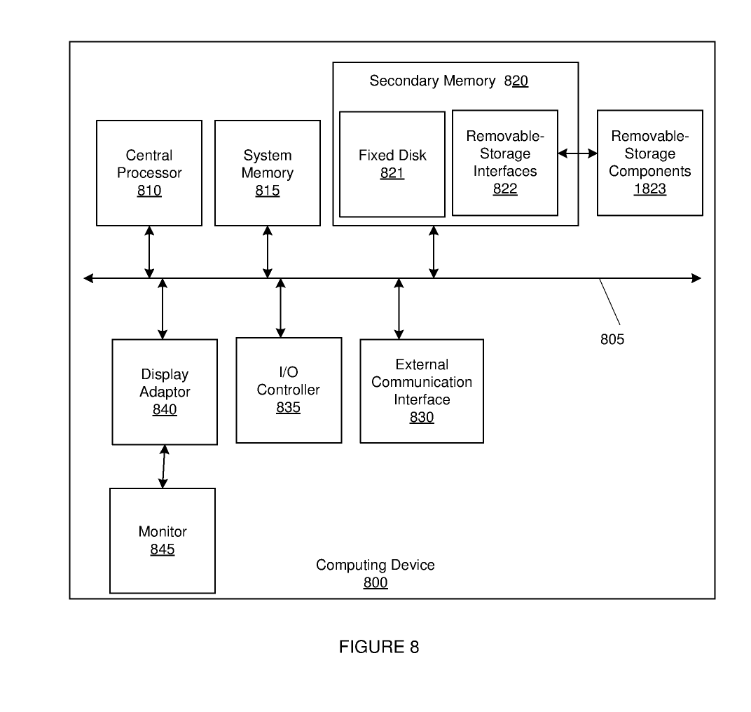

FIG. 8 illustrates an example of a computing device (800) in which various aspects of the disclosure may be implemented, for example, in an embodiment wherein the mobile device is a tablet device. The computing device (800) may be suitable for storing and executing computer program code. The various participants and elements in the previously described system diagrams may use any suitable number of subsystems or components of the computing device (800) to facilitate the functions described herein.

The computing device (800) may include subsystems or components interconnected via a communication infrastructure (805) (for example, a communications bus, a cross-over bar device, or a network). The computing device (800) may include at least one central processor (810) and at least one memory component in the form of computer-readable media.

The memory components may include system memory (815), which may include read only memory (ROM) and random access memory (RAM). A basic input/output system (BIOS) may be stored in ROM. System software may be stored in the system memory (815) including operating system software.

The memory components may also include secondary memory (820). The secondary memory (820) may include a fixed disk (821), such as a hard disk drive, and, optionally, one or more removable-storage interfaces (822) for removable-storage components (823).

The removable-storage interfaces (822) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (822) may also be in the form of ports or sockets for interfacing with other forms of removable-storage components (823) such as a flash memory drive, external hard drive, or removable memory chip, etc.

The computing device (800) may include an external communications interface (830) for operation of the computing device (800) in a networked environment enabling transfer of data between multiple computing devices (800). Data transferred via the external communications interface (830) may be in the form of signals, which may be electronic, electromagnetic, optical, radio, or other types of signal.

The external communications interface (830) may enable communication of data between the computing device (800) and other computing devices including servers and external storage facilities. Web services may be accessible by the computing device (800) via the communications interface (830).

The external communications interface (830) may also enable other forms of communication to and from the computing device (800) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (810).

A computer program product may be provided by a non-transient computer-readable medium, or may be provided via a signal or other transient means via the communications interface (830).

Interconnection via the communication infrastructure (805) allows a central processor (810) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (800) either directly or via an I/O controller (835). These components may be connected to the computing device (800) by any number of means known in the art, such as a serial port.

One or more monitors (845) may be coupled via a display or video adapter (840) to the computing device (800).

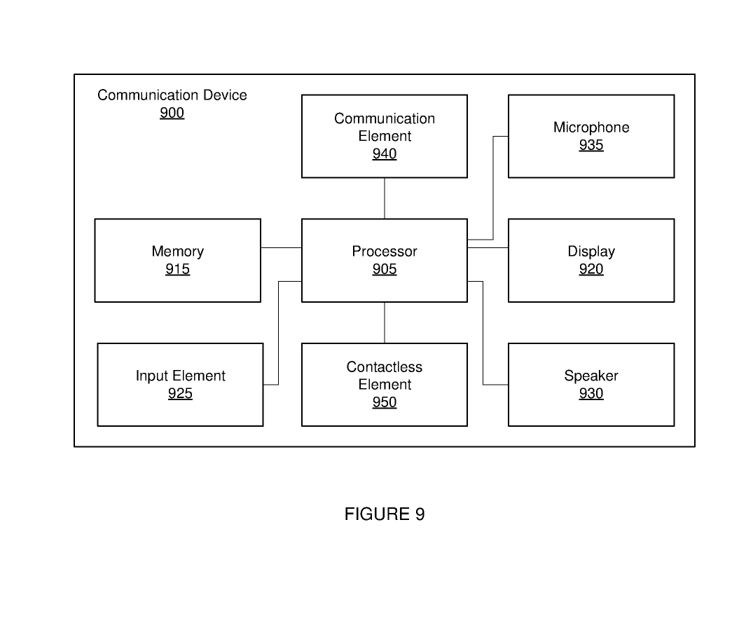

FIG. 9 shows a block diagram of a communication device (900) that may be used in embodiments of the disclosure. The communication device (900) may be a cell phone, a feature phone, a smart phone, a satellite phone, or a computing device having a phone capability.

The communication device (900) may include a processor (905) (e.g., a microprocessor) for processing the functions of the communication device (900) and a display (920) to allow a user to see the phone numbers and other information and messages. The communication device (900) may further include an input element (925) to allow a user to input information into the device (e.g., input buttons, touch screen, etc.), a speaker (930) to allow the user to hear voice communication, music, etc., and a microphone (935) to allow the user to transmit his or her voice through the communication device (900).

The processor (910) of the communication device (900) may connect to a memory (915). The memory (915) may be in the form of a computer-readable medium that stores data and, optionally, computer-executable instructions.

The communication device (900) may also include a communication element (940) for connection to communication channels (e.g., a cellular telephone network, data transmission network, Wi-Fi network, satellite-phone network, Internet network, Satellite Internet Network, etc.). The communication element (940) may include an associated wireless transfer element, such as an antenna.

The communication element (940) may include a subscriber identity module (SIM) in the form of an integrated circuit that stores an international mobile subscriber identity and the related key used to identify and authenticate a subscriber using the communication device (900). One or more subscriber identity modules may be removable from the communication device (900) or embedded in the communication device (900).

The communication device (900) may further include a contactless element (950), which is typically implemented in the form of a semiconductor chip (or other data storage element) with an associated wireless transfer element, such as an antenna. The contactless element (950) may be associated with (e.g., embedded within) the communication device (900) and data or control instructions transmitted via a cellular network may be applied to the contactless element (950) by means of a contactless element interface (not shown). The contactless element interface may function to permit the exchange of data and/or control instructions between mobile device circuitry (and hence the cellular network) and the contactless element (950).

The contactless element (950) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (900) and an interrogation device. Thus, the communication device (900) may be capable of communicating and transferring data and/or control instructions via both a cellular network and near field communications capability.

The data stored in the memory (915) may include: operation data relating to the operation of the communication device (900), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (900) to selected receivers.

The communication device (900) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method for authorizing transactions using a mobile device, comprising, on the mobile device, the steps of:
setting an automatic authorization rule, where a transaction is to be automatically authorized when the transaction fulfills the automatic authorization rule;
setting an input required rule, where a transaction is to be authorized by a user of the mobile device when the transaction fulfils the input required rule;
storing the automatic authorization and input required rules at the mobile device;
enabling the automatic authorization and input required rules to be configured by a user of the mobile device;
in response to the user providing payment credentials to a merchant and the merchant processing a transaction for payment from the user:
receiving a transaction authorization request;
determining if a rule is applicable to the transaction;
in response to the automatic authorization rule being applicable, automatically authorizing the transaction; and
in response to the input required rule being applicable, prompting the user to authorize the transaction.

2. The method as claimed in claim 1 which includes the steps of setting and storing an automatic rejection rule, where a transaction is to be automatically rejected when the transaction fulfills the automatic rejection rule; enabling the automatic rejection rule to be configured by a user of the mobile device; and, in response to the user providing payment credentials to a merchant, the merchant processing a transaction for payment from the user, receiving a transaction authorization request, and determining that the automatic rejection rule is applicable, automatically rejecting the transaction.

3. The method as claimed in claim 1 wherein the input required rule requires an input from the user in the form of a confirmation indicator to authorize the transaction.

4. The method as claimed in claim 1 wherein the input required rule requires an input from the user in the form of an authentication token to authorize the transaction.

5. The method as claimed in claim 1 wherein the automatic authorization rule is that a value of the transaction is less than an automatic authorization threshold and the input required rule is that the value of the transaction is equal to or above the automatic authorization threshold.

6. The method as claimed in claim 2 wherein the automatic authorization rule is that a value of the transaction is less than an automatic authorization threshold, the input required rule is that the value of the transaction is equal to or above the automatic authorization threshold but below an automatic rejection threshold, and the automatic rejection rule is that the value of the transaction is equal to or above the automatic rejection threshold.

7. The method as claimed in claim 1 wherein the input required rule includes a first and a second part, applicability of the first part requiring an input from the user in the form of a confirmation indicator to authorize the transaction, and applicability of the second part requiring an input from the user in the form of an authentication token to authorize the transaction.

8. The method as claimed in claim 7 wherein the automatic authorization rule is that a value of the transaction is less than an automatic authorization threshold, the first part of the input required rule is that the value of the transaction is equal to or above the automatic authorization threshold but below an input required threshold, and the second part of the input required rule is that the value of the transaction is equal to or above the input required threshold.

9. The method as claimed in claim 2 wherein the input required rule includes a first and a second part, applicability of the first part requiring an input from the user in the form of a confirmation indicator to authorize the transaction, and applicability of the second part requiring an input from the user in the form of an authentication token to authorize the transaction, wherein the automatic authorization rule is that a value of the transaction is less than an automatic authorization threshold, the first part of the input required rule is that the value of the transaction is equal to or above the automatic authorization threshold but below an input required threshold, the second part of the input required rule is that the value of the transaction is equal to or above the input required threshold but below a rejection threshold, and the automatic rejection rule is that the value of the transaction is equal to or above the rejection threshold.

10. The method as claimed in claim 1 wherein the automatic authorization rule is applicable when a transaction has any one or more of the properties selected from the list of: originates from a specific merchant; originates from a specific geographic location; occurs during a certain time of day; will not elevate the amount of transactions occurring in a specific time period to a predetermined number; will not elevate the value of transactions authorized in a specific time period to a predetermined amount; and will not reduce the funds available in a user's account to a value lower than a predetermined value.

11. The method as claimed in claim 1 wherein the input required rule is applicable when a transaction has any one or more of the properties selected from the list of: originates from a specific merchant; originates from a specific geographic location; occurs during a certain time of day; will elevate the amount of transactions occurring in a specific time period to a predetermined number; will elevate the value of transactions authorized in a specific time period to a predetermined amount; and will reduce the funds available in a user's account to a value lower than a predetermined value.

12. The method as claimed in claim 2 wherein the automatic rejection rule is applicable when a transaction has any one or more of the properties selected from the list of: originates from a specific merchant; originates from a specific geographic location; occurs during a certain time of day; will elevate the amount of transactions occurring in a specific time period to a predetermined number; will elevate the value of transactions authorized in a specific time period to a predetermined amount; and will reduce the finds available in a user's account to a value lower than a predetermined value.

13. The method as claimed in claim 7 wherein the first part or the second part of the input required rule is applicable when a transaction has any one or more of the properties selected from the list of: originates from a specific merchant; originates from a specific geographic location; occurs during a certain time of day; will elevate the amount of transactions occurring in a specific time period to a predetermined number; will elevate the value of transactions authorized in a specific time period to a predetermined amount; and will reduce the funds available in a user's account to a value lower than a predetermined value.

14. The method as claimed in claim 1 wherein the rules are applicable to an account for which payment credentials are stored at the mobile device, or in association with the mobile device.

15. The method as claimed in claim 1 wherein the user is only allowed to configure any of the rules upon providing authentication in the form of an authentication token.

16. The method as claimed in claim 15 wherein the authentication token is selected from the group consisting of a PIN code, a pass code, a password and a passphrase.

17. A system for authorizing transactions using a mobile device, comprising:
a rule component including:
a rule setting component for at least setting an automatic authorization rule, where a transaction is to be automatically authorized when the transaction fulfills the automatic authorization rule and setting a input required rule, where a transaction is to be authorized by a user of the mobile device when the transaction fulfils the input required rule;
a query receiving component for receiving a transaction authorization request in response to a user of the mobile device providing payment credentials to a merchant and the merchant processing a transaction for payment from the user;
a rule applying component for determining if a rule is applicable to the transaction;
an automatic response component for, in response to the automatic authorization rule being applicable, automatically authorizing the transaction;
an input requesting component for, in response to the input required rule being applicable, prompting the user to authorize the transaction;
a secure element in the mobile device for storing the automatic authorization and input required rules at the mobile device.

18. The system as claimed in claim 17 wherein the mobile device includes a memory component for storing an authentication token required to configure the stored rules, and a comparing component for comparing a provided authentication token with the stored authentication token.

19. The system as claimed in claim 17 wherein the mobile device is equipped with a hardware security module (HSM).

20. (canceled)

21. (canceled)

22. A computer program product for authorizing transactions using a mobile device, the computer program product comprising a computer-readable medium having stored computer-readable program code for performing the steps of:
setting an automatic authorization rule, where a transaction is to be automatically authorized when the transaction fulfills the automatic authorization rule;
setting an input required rule, where a transaction is to be authorized by a user of the mobile device when the transaction fulfils the input required rule;
storing the automatic authorization and input required rules at the mobile device;
enabling the automatic authorization and input required rules to be configured by a user of the mobile device;
in response to the user providing payment credentials to a merchant and the merchant processing a transaction for payment from the user:
receiving a transaction authorization request;
determining if a rule is applicable to the transaction;
in response to the automatic authorization rule being applicable, automatically authorizing the transaction; and
in response to the input required rule being applicable, prompting the user to authorize the transaction.
